(19) United States
(12) Patent Application Publication
(10) Pub. No.: US 2010/0045028 A1
(43) Pub. Date: Feb. 25, 2010

(54) METHOD OF CONNECTING A MEMBER TO AN END OF A MULTILAYER TUBE

(76) Inventor: Philippe Blivet, Rennes (FR)

Correspondence Address: JOHN MOLNAR JR., PARKER-HANNIFIN CORPORATION, 6035 PARKLAND BOULEVARD, CLEVELAND, OH, 44124-4141, US

(21) Appl. No.: 12/508,612

(22) Filed: Jul. 24, 2009

(30) Foreign Application Priority Data
Jan. 29, 2007 (FR) 0700598
Dec. 20, 2007 (FR) PCT/FR07/02130

(51) Int. Cl. F16L 55/00; B29C 65/06

(52) U.S. Cl. 285/21.1; 156/73.5

(57) ABSTRACT

Method of connecting an end portion of a multilayer tube to a channel of an element, at least the end portion of the tube including a surface layer that is weldable to at least one substantially annular wall of the element, and the assembly connected by the method. The method including the step of causing an area of the surface layer of the end portion of the tube to rub against the wall of the element so as to friction-weld the end portion of the tube to the element, the method including the prior step of turning back the end portion onto itself in such a manner that the area of the surface layer of the end portion extends facing the wall of the element.

### CROSS-REFERENCE TO RELATED CASES

This application is continuation of copending International Application No. PCT/FR07/002130 filed Dec. 20, 2007, which designated the United States, and which claims priority to French Patent Application 0700598, filed Jan. 29, 2007, the disclosure of each of which is expressly incorporated herein by reference.

### BACKGROUND OF THE INVENTION

The present invention relates to a method of connecting an end portion of a multilayer tube to a channel of an element. The tube and the element may be designed to form parts of a circuit for conveying fluid. The element may thus be a fluid emitter or receiver element such as a pipe, an endpiece, a coupling, a pump, or a tank.

A method of connecting a multilayer tube to a channel of a circuit element by friction-welding is known. The tube includes, at least over an end portion, a surface layer that is weldable to a dedicated wall of the circuit element. The wall is a substantially annular surface arranged in the channel of the element. Such a method comprises steps of putting an area of the surface layer of the end portion into contact with the wall of the circuit element and causing said area of the surface layer to rub against the wall until the end portion of the tube is friction-welded to the circuit element. In general, the wall is of frustoconical shape with a small slope for clamping the tube a little and for increasing friction. If the surface layer is covered in at least one other layer beside the wall of the circuit element, the surface layer being situated for example on the inside of the tube while the wall is the wall defining the channel of the element into which the end portion is to be inserted, it is necessary to begin by stripping the surface layer by removing, e.g. by cutting away, an area of the layer that covers it. Nevertheless, that weakens the tube structurally and may lead firstly to the tube collapsing during friction-welding and secondly to a future risk of leakage by significantly degrading the mechanical, chemical, and thermal characteristics of the tube in this zone.

### SUMMARY OF THE INVENTION

A feature of the invention is to obtain connections with multilayer tubes by friction-welding, which connections are strong and relatively easy to make.

To this end, the invention provides a method of connecting an end portion of a multilayer tube to a channel of an element, at least the end portion of the tube including a surface layer that is weldable to at least one substantially annular wall of the element, the method including the step of causing an area of the surface layer of the end portion of the tube to rub against the wall of the element so as to friction-weld the end portion of the tube to the element, the method further comprising the prior step of turning back the end portion onto itself in such a manner that the area of the surface layer of the end portion extends facing the wall of the element.

After the end portion has been turned back, the end portion possesses two thicknesses that are folded down, rolled up, or pressed one against the other such that the weldable surface layer is visible both on the outside and on the inside of the turned-back end portion. Thus, the weldable surface layer is brought face to face with the dedicated wall of the element without requiring any material to be removed, and with this being achieved merely by turning back the end portion onto itself. In addition, the end portion as turned back in this way presents double thickness, thereby increasing its strength.

In three particular implementations:

the surface layer is situated on an outside of the tube and the end portion is turned back towards the inside of the tube;

the surface layer is situated on the inside of the tube and the end portion is turned back towards the outside of the tube; and

the element has two substantially annular walls that are coaxial with each other and arranged in such a manner that the surface layer is in contact with both walls during friction-welding, on the inside and on the outside of the turned-back end portion.

Various connection configurations are thus possible. The strength of the connection that results from the third implementation is relatively high.

In a fourth particular implementation, the element is an end portion of a second tube, the method comprising the steps of belling said end portion of the second tube, of turning the end portion of the first tube back towards the outside, the weldable surface layer being situated initially on the inside of the first tube, of inserting the turned-back end portion of the first tube in the belled end portion of the second tube, and of friction-welding them together.

Two tubes can thus be connected together securely.

In a particular implementation, turning back is performed by pressing the end portion of the tube against a tool having a shaping surface formed with a plane annular groove having a curved bottom for initiating turning back and bounded by a first flank formed by a coaxial cylindrical surface for guiding the end portion of the tube towards the bottom of the groove, and a second flank that diverges relative to the first flank and, advantageously, turning back comprises a roughing-out stage performed by means of said tool, the roughed-out end portion forming an acute angle relative to the non-turned-back portion of the tube, and a finishing stage in which the roughed-out end portion is pressed against a second tool having a cylindrical guide surface for guiding the end portion of the tube towards a coaxial annular abutment arranged to hold down the end portion against the non-turned-back portion of the tube.

Turning back is then performed simply and effectively, possibly in two stages if that is made necessary by the material of the tube. It is also possible to perform turning back while hot so as to soften the tube and to avoid damaging it.

The invention also provides an assembly comprising a tube connected to a channel of an element, the tube possessing a turned-back end portion having a surface layer welded to at least one wall of the element.

These and other advantages will be readily apparent to those skilled in the art based upon the disclosure contained herein.

The present invention, accordingly, comprises the construction, combination of elements, and/or arrangement of parts and steps which are exemplified in the detailed disclosure to follow.

### BRIEF DESCRIPTION OF THE DRAWINGS

For a fuller understanding of the nature and objects of the invention, reference should be had to the following detailed description taken in connection with the accompanying drawings wherein:

FIG. 1 is a longitudinal section view of an assembly in accordance with a first embodiment of the invention;

FIG. 2 is a longitudinal section view of an assembly in accordance with a second embodiment of the invention;

FIG. 3 is a longitudinal section view of an assembly in accordance with a third embodiment of the invention, while being assembled;

FIG. 4 is a longitudinal section view of an assembly in accordance with a fourth embodiment of the invention, prior to assembly; and

FIG. 5 is a diagrammatic view showing how the end portion is turned back.

The drawings will be described further in connection with the following Detailed Description of the Invention.

### DETAILED DESCRIPTION OF THE INVENTION

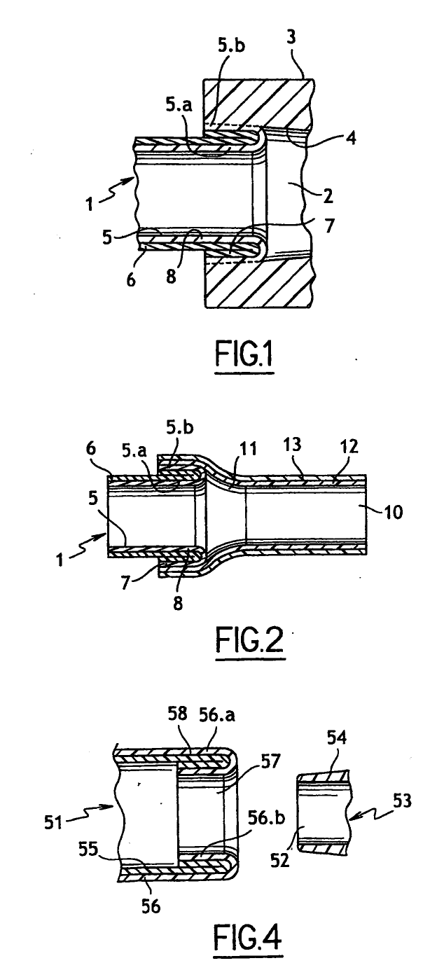

With reference to FIG. 1, the assembly in accordance with the first embodiment of the invention comprises a tube, given overall reference 1, connected at one end 2 to a channel in an element 3, here an element of a circuit for conveying fluid. The end of the channel 2 is defined by a wall 4 that is substantially annular. More precisely, the wall 4 is slightly frustoconical, flaring towards the mouth at the end of the channel 2.

The tube 1 is a multilayer tube having an inner surface layer 5 and an outer surface layer 6. The inner surface layer 5 is of a material that can be welded to the material of the wall 4: the wall 4 and the inner surface layer 5 may be made out of the same thermoplastic material, for example. The tube 1 possesses an end portion 7 that is turned back on the outside. Here the end portion 7 is turned back through 180°, i.e. the end portion 7 is pressed against an adjacent portion 8 of the tube 1 that has not been turned back. Thus, the inner surface layer 5, at the end portion 7, comprises a area 5.a extending on the inside of the tube and an area 5.b that extends on the outside of the tube 1. The area 5.b of the inner surface layer 7 is welded to the wall 4 of the element 3.

This assembly is made by implementing a connection method comprising a step of turning back the end portion 7 of the tube 1, and a step of friction-welding the end portion 7 to the element 3.

The turning back is performed in a roughing stage and a finishing stage (see FIG. 5).

The roughing stage consists in applying the end portion 7 of the tube 1 against a tool 100 having a shaping surface formed by a plane annular groove, given overall reference 101, having a curved bottom 102 for initiating turning back, and bounded, here on the inside, by a first flank 103 formed by a coaxial cylindrical surface for guiding the end portion 7 of the tube 1 towards the bottom 102 of the groove 101, and on the outside, by a second flank 104 that diverges relative to the first flank 103. At the end of the roughing stage, the roughed-out end portion 7 forms an acute angle with the adjacent non-turned-back portion 8 of the tube 1.

The finishing stage consists in applying the roughed-out end portion 7 against a second tool 200 having a shaping surface constituted by a plane annular groove given overall reference 201 with a curved bottom 202 to form the end edge of the end portion 7 and bounded, here on the inside by a first flank 203 formed by a cylindrical surface for guiding the end portion of the tube into the groove 201, and on the outside by a second flank 204 formed by a cylindrical surface that is coaxial with the first flank and that has its edge opposite from the bottom 202 in the form of a coaxial annular abutment arranged to fold down the roughed-out end portion 7 against the adjacent non-turned-back portion 8 of the tube 1.

Turning back may be performed hot or cold, or in a single stage, depending on the mechanical properties of the tube (flexibility, material, presence of a metal layer. Turning back may also be performed in a single stage if the end portion 7 does not need to be pressed against the adjacent non-turned-back portion 8.

The method is continued by the step of causing the area 5.b of the inner surface layer 5 of the end portion 7 of the tube 1 to rub against the wall 4 of the element 3 so as to friction-weld the end portion 7 of the tube 1 to the element 3. Friction-welding is performed in conventional manner, here by relative rotation of the end portion 7 and the element 3.

Elements that are identical or analogous are given identical numerical references in the description below of other embodiments of the assembly in accordance with the invention.

With reference to FIG. 2, the assembly in accordance with the second embodiment comprises a tube 1 identical to that of the first embodiment. The element is a second tube 10 having a belled end portion 11. The second tube 10 has an inner surface layer 12 and an outer surface layer 13. The inner surface layer 12 is made of a material suitable for welding with the material of the inner surface layer 5 of the tube 1.

The connection method of the invention comprises the step of belling the end portion 11 of the second tube 10, of turning back the end portion 7 of the first tube 1 towards the outside so as to cause the inner surface layer 5 to face the inner surface layer 12, of inserting the turned-back end portion 7 of the first tube 1 into the belled end portion 11 of the second tube 10, and of friction-welding these two portions together.

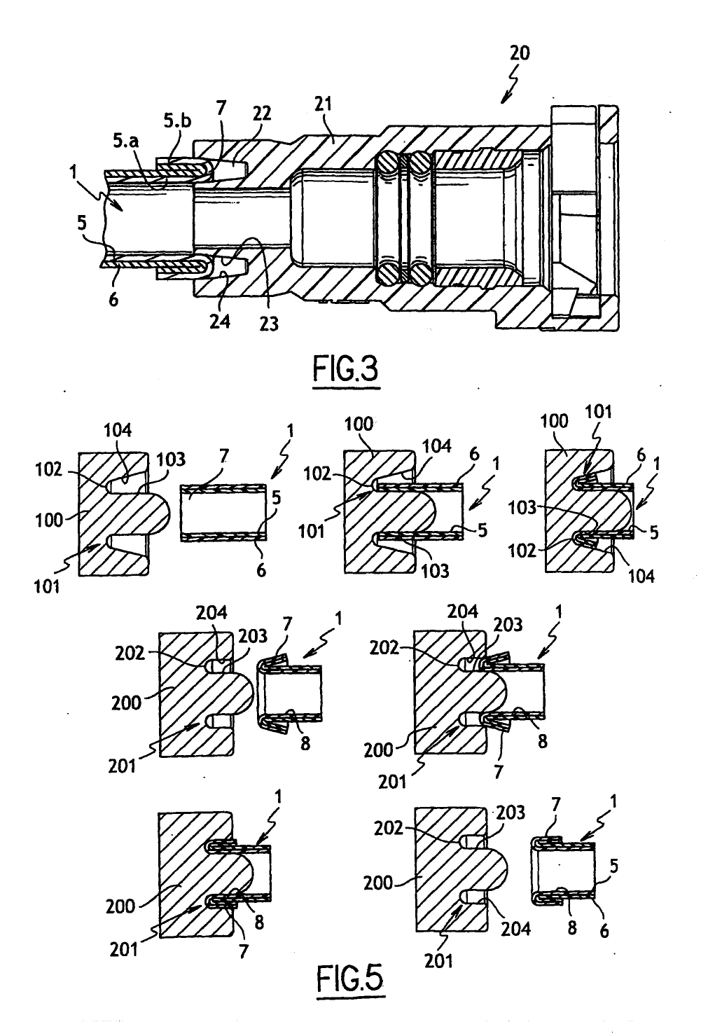

With reference to FIG. 3, the assembly in accordance with the third embodiment comprises a tube 1 identical to that of the first embodiment. The element is a conventional coupling 20 having a tubular body 21 with one end provided with a plane groove 22 having its bottom bounded on the inside and on the outside by diverging flanks 23 and 24 that form walls suitable for welding with the areas 5.a and 5.b of the inner surface layer 5 of the tube 1. The diverging flanks 23 and 24 are connected to the areas 5.a and 5.b of the inner surface layer 5 of the tube 1 by welding.

The tube 1 is connected to the coupling 20 as described above.

In a variant, it is possible for the end portion to be turned back directly in the groove 22 by providing for said groove to have a bottom that forms a surface suitable for initiating the turning back of the end portion (as with the tubes 100 and 200). The force required to insert the end portion in the groove 22 needs to be sufficient to achieve turning back, and the groove 22 must be wide enough to allow turning back to take place and to receive the double thickness (turning back can thus be performed immediately before welding, or even almost simultaneously with welding).

In order to avoid welding occurring before the end portion has been turned back, it is possible to use a lower speed of rotation for turning back (so as to limit heating) and then to accelerate the speed of rotation to perform welding.

With reference to FIG. 4, the assembly in accordance with the fourth embodiment comprises a tube, given overall reference 51, that is connected to a male end 52 of a channel of an element 53, here an element of a circuit for conveying fluid. The end of the channel 52 is defined by a substantially annular wall 54 and more precisely by a wall that is slightly frustoconical, flaring towards the mouth at the end of the channel 52.

The tube 51 is a multilayer tube having an inner surface layer 55 and an outer surface layer 56. The outer surface layer 56 is made of a material suitable for welding to the material of the wall 54: the wall 54 and the inner surface layer 56 may be made of the same thermoplastic material, for example. The tube 51 possesses an end portion 57 that is turned back towards the inside. The end portion 57 in this example is turned through 180°, i.e. the end portion 57 is pressed against an adjacent portion 58 of the tube 1 that is not turned back. Thus, at the end portion 57, the outer surface layer 56 comprises an area 56.a extending over the outside of the tube and an area 56.b extending over the inside of the tube 1. The area 56.b of the inner surface layer 57 is welded to the wall 54 of the element 53.

The end portion 57 is turned back by means of tools analogous to those described with reference to the first embodiment, the guide surface then being on the outside.

As it is anticipated that certain changes may be made in the present invention without departing from the precepts herein involved, it is intended that all matter contained in the foregoing description shall be interpreted as illustrative and not in a limiting sense. All references including any priority documents cited herein are expressly incorporated by reference.

What is claimed is:

1. A method of connecting an end portion of a first tube to a channel of a member, the tube having an innermost tube layer and an outermost tube layer, and the member having at least an annular first wall defining the channel, a first one of the innermost or the outermost tube layer being friction weldable to the first wall, the method comprising the steps of:
(a) receiving one of the tube end portion and the first wall coaxially in the other;
(b) rotating one of the tube end portion and the first wall relative to the other whereby the first one of the innermost or the outermost tube layer is friction welded to the first wall; and
(c) prior to step (b), turning the tube end portion into one of the innermost tube layer or over the outermost tube layer of an unturned portion of the tube such that the first one of the tube layers is disposed in contact with the first wall when the one of the tube end portion and the first wall is received coaxially in the other.

2. The method of claim 1 wherein:
the first one of the tube layers is the outermost tube layer and the tube end portion is turned in step (c) into the innermost tube layer of the unturned portion of the tube; and
the first wall is received in step (a) coaxially in the tube end portion.

3. The method of claim 1 wherein:
the first one of the tube layers is the innermost tube layer and the tube end portion is turned in step (c) over the outermost tube layer of the unturned portion of the tube; and
the tube end portion is received in step (a) coaxially in the first wall.

4. The method of claim 1 wherein:
the member further has an annular second wall disposed coaxially with the first wall; and
the first one of the tube layers is disposed in contact with both the first wall and the second wall when the one of the tube end portion and the first wall is received coaxially in the other.

5. The method of claim 1 wherein:
the member is a second tube having a second tube end portion defining the channel;
the method comprises the additional step prior to step (a) of belling the second tube end portion to define the first wall; and
the tube end portion of the first tube is received in step (a) coaxially in the first wall.

6. The method of claim 1 wherein the tube end portion is turned in step (c) into the one of the innermost tube layer or over the outermost tube layer of the unturned portion of the tube such that the other one of the innermost or outermost tube layer in the tube end portion is disposed in contact with the other one of the innermost tube layer or the outermost tube layer of the unturned portion of the tube.

7. The method of claim 1 wherein:
the tube end portion is turned in step (c) over the outermost tube layer of the unturned portion of the tube by pressing the tube end portion against the first shaping surface of a first forming tool, the first shaping surface being formed as an annular groove having a curved bottom and a generally cylindrical inner flank extending from the bottom and an outer flank disposed coaxial with the inner flank, the outer flank extending from the bottom as diverging away from the inner flank, the tube end portion being received over the inner flank and as pressed against the first shaping surface is guided by the inner flank towards the bottom and then is turned by the bottom into the outer flank and advanced therealong over the outermost tube layer of the unturned portion of the tube.

8. The method of claim 7 wherein the tube end portion turned in step (c) is disposed over the outermost tube surface of the unturned portion of the tube at an acute angle thereto, the method further comprising the additional step of:
(d) further turning the tube end portion by pressing the tube end portion formed in step (c) against the second shaping surface of a second forming tool, the second shaping surface being formed as a generally cylindrical inner flank and a generally cylindrical outer flank disposed coaxial with the inner flank and extending generally parallel thereto, the tube end portion being received over the inner flank and as pressed against the second shaping surface is guided by the inner flank into compression between the inner flank and the outer flank bottom such that the outermost tube layer in the tube end portion is disposed in contact with the outermost tube layer of the unturned portion of the tube.

9. A connection of an end portion of a first tube to a channel of a member, the tube having an innermost tube layer and an outermost tube layer, and the member having at least an annular first wall defining the channel, a first one of the innermost or the outermost tube layer being weldable to the first wall, the connection comprising:
the tube end portion being turned into one of the innermost tube layer or over the outermost tube layer of an unturned portion of the tube;
one of the tube end portion and the first wall being received coaxially in the other with the first one of the tube layers being disposed in contact with the first wall; and
the first one of the innermost or the outermost tube layer is welded to the first wall.

10. The connection of claim 9 wherein:
the first one of the tube layers is the outermost tube layer and the tube end portion is turned into the innermost tube layer of the unturned portion of the tube; and
the first wall is received coaxially in the tube end portion.

11. The connection of claim 9 wherein:
the first one of the tube layers is the innermost tube layer and the tube end portion is turned over the outermost tube layer of the unturned portion of the tube; and
the tube end portion is received coaxially in the first wall.

12. The connection of claim 9 wherein:
the member further has an annular second wall disposed coaxially with the first wall; and
the first one of the tube layers is disposed in contact with both the first wall and the second wall.

13. The connection of claim 9 wherein:
the member is a second tube having a second tube end portion defining the channel, the second tube end portion being belled to define the first wall; and
the tube end portion of the first tube is received coaxially in the first wall.

14. The connection of claim 9 wherein the tube end portion is turned into the one of the innermost tube layer or over the outermost tube layer of the unturned portion of the tube such that the other one of the innermost or outermost tube layer in the tube end portion is disposed in contact with the other one of the innermost tube layer or the outermost tube layer of the unturned portion of the tube.
